(19) United States
(12) Patent Application Publication
(10) Pub. No.: US 2008/0115063 A1
(43) Pub. Date: May 15, 2008

(54) Media assembly

(75) Inventor: Christopher J. Glenn, Edina, MN (US)

Correspondence Address: BROOKS, CAMERON & HUEBSCH , PLLC, 1221 NICOLLET AVENUE , SUITE 500, MINNEAPOLIS, MN, 55403, US

(73) Assignee: Flagpath Venture VII, LLC

(21) Appl. No.: 11/598,404

(22) Filed: Nov. 13, 2006

(51) Int. Cl. G06F 3/16

(52) U.S. Cl. 715/728

(57) ABSTRACT

Embodiments of media assembly are disclosed. In one method embodiment, the method includes manipulating at least one textual script file representing a number of component performance elements of a media program, presenting a visual representation of at least one of the number of component performance elements, cueing the artist to begin performing a take of a component performance element, capturing an artist's performance of at least one of the number of component performance elements, indicating whether mistakes were made by the artist during the take of the component performance element, and storing at least one recorded artist performance in memory.

### BACKGROUND

Media assembly has historically been a very labor-intensive process, with creative or technical people making individual decisions at each edit point in an assembly process. For example, the process of recording and editing audio narration has been segmented into many discrete steps. In one approach, a recording engineer starts a recording device and cues a voiceover artist in a soundproof booth to begin reading a paper script. The artist then performs multiple takes of the script into a microphone.

In media production parlance, a “take” is a term used to refer to one individual rendition of a performance be it a scene, a shot, a paragraph or a line. For example, one often hears a director saying “take two” to indicate that he would like to perform another rendition of some subset of the performance. In most production scenarios, all of the takes, even the ones with mistakes, are saved on a storage medium, such as magnetic tape, film, or a hard disk, for later review and editing by the engineer and other production staff.

In some instances, during the editing phase of an audio production, the recording engineer or audio editor listens to the various takes for each performance element, decides which takes represent the best performance, and assembles those best takes into a final combined performance. This final combined performance may be the entire production itself (e.g., be broadcast-ready as is) or it could be just the artist's final narrative performance of the program (e.g., a mistake-free performance of the narration to be further manipulated later by an editor to add music, video, commercials, etc.)

In such approaches, the audio editor often spends two or three times as much time editing the narration as the voiceover artist and engineer did recording it. With such an approach, the editor (or the artist themselves acting as the editor) may have to subsequently review and edit the individual takes into a final narration track for the audio or video production.

### BRIEF DESCRIPTION OF THE DRAWINGS

FIG. 1 is a block diagram that illustrates the elements of an embodiment for media assembly.

FIG. 2 is a screen shot and a block diagram that further illustrates the elements of an embodiment for media assembly.

FIG. 3 is a flow chart that illustrates a method embodiment for media assembly.

### DETAILED DESCRIPTION

Media assembly systems, devices, and methods can allow a performance artist to self-manage the recording process such that the traditional post-recording editing process can be completed without human interaction. A performance can be audio-only, with the performance recorded through a capturing device such as a microphone. A performance can be audio-visual, with the performance recorded through capturing devices such as a camera and a microphone. Or, a performance can be visual-only, with the performance captured through a camera.

Such embodiments can create value, for example, by eliminating the costly editing of raw media recordings such that the final combined audio or audio-visual performance that is created by the technology is “broadcast-ready”, able to be immediately posted to the internet, duplicated onto CD, and/or otherwise distributed to the audience without additional editing required. That said, while the final combined performance in such embodiments is “broadcast-ready” and could be immediately distributed, any given production may use embodiments to allow individual artists to create final combined performances of their own performances and then further edit together multiple artists' final combined performances along with the addition of music, graphics and special effects to make a larger program.

Embodiments of the present disclosure can be utilized in a number of markets. For example, one market for such technology is in self-published audio book creation. In utilizing some prior art approaches, if a self-published author wants to create an audio book of their written work, they must either hire a production company or learn how to edit audio content.

In many cases, the time it takes to edit audio content, especially for amateur voiceover artists, is three to four times the amount of time to simply read the text into a microphone. Also, since audio editing is quite technical in nature, it is unlikely that most self-published authors have the skill to master the process.

Other suitable markets include, but are not limited to voiceover for audio versions of print stories, narration for museum tours, radio or television documentaries, public address announcements or any other kind of media announcement where it is valuable to capture multiple takes of a media performance which can then be automatically assembled from the best takes into a final combined performance. Furthermore, various features, structures, and/or characteristics of the systems and devices described through out this specification may be combined in any suitable manner in one or more embodiments.

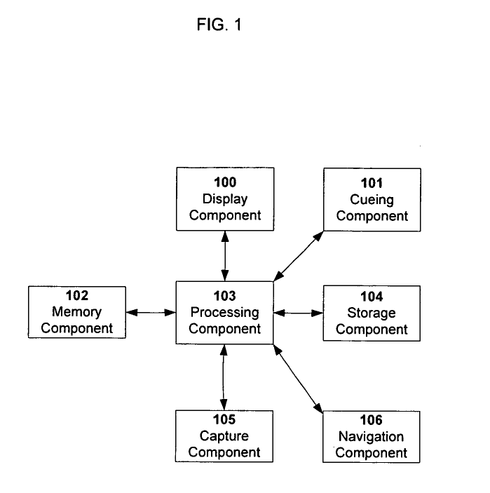

FIG. 1 is a block diagram that illustrates the elements of an embodiment for media assembly. The components of the system can be fully self-contained inside a single unit, such as with a personal computer with a processor 103, a memory 102, a microphone (e.g., as its capture component 105), a keyboard (e.g., as its navigation component 106), a hard drive (e.g., as its storage component 104), and a LCD screen (e.g., as both its display and cueing component 100, 101).

The components of the system can also be separate in some embodiments. For example, in some embodiments, a device can provide the processor and memory components 103, 102, a television or radio studio can provide the capturing component 105, a user interface (e.g., a button) can provide the navigation component 106, a web server can provide the storage component 104, a television can act as the display component 100, and a light source (e.g., a red light bulb) can act as the cueing component 101.

In some embodiments for media assembly, an assembly embodiment can include a memory component 102 for storing at least one textual script file representing a number of component performance elements of a media program. Such component performance elements can be individual paragraphs of a larger audio book or they can be individual words or phrases that, out of content, do not have much meaning.

Specifically, in some embodiments where individual words or phrases are considered component performance elements, the first component performance element can include “The United States Patent and Trademark Office” and the second component performance element can include “The USPTO”. In this example, the first element would be recorded by the artist such that it may be included in one version of a final output distributed to the public and the second element would be recorded such that it may be included in another version for internal USPTO employees. In other words, component performance elements do not have to make up a comprehensive, linear narrative; rather, they can be any subset of elements of a single media program or multiple variations of a media program.

An embodiment for media assembly can also include a display component 100 for presenting a visual representation of at least one of the number of component performance elements to the performance artist. In some embodiments, this can be via a CRT or LCD computer screen that can be read by the performance artist while recording a take of a component performance element. In some embodiments, only one component performance element can be included at a time on the display component, in other embodiments, multiple component performance elements can be displayed to allow the artist to better see the context of the current component performance element.

In some embodiments, the display of the component performance element can be further enhanced to emphasize parts of speech such as, for example, italicizing quotations or coloring certain parts of speech such as nouns or verbs. In some embodiments, other information such as a threshold time of the component performance element (e.g., indicating that a take of a performance must be no more than 8 seconds) can be included on the display.

An embodiment for media assembly can also include a cueing component 101 for alerting the artist to begin performing a take of a component performance element. This cueing component 101 can be a red “tally light” on top of the display device, it can be a virtual tally light on the display itself or it can be a series of audible beeps emanating from a speaker nearby the display component. The cueing component 101 can also be a non audio-visual cue such as a physical tap or electrical trigger that can be interpreted by the artist as a signal to begin a take of a performance of a component performance element.

An embodiment for media assembly can also include a capturing component 105 for recording a take of an artist's performance of at least one of the number of component performance elements. The capturing component can include a microphone and/or camera, a mixing board or mixing software and a video switching board or video switcher.

An embodiment for media assembly can also include a navigation component 106 to allow a person to indicate when mistakes were made by an artist in performing a take of a component performance element. The navigation component can be a keyboard, a mouse, a button, or other user interface mechanism to allow the user make an indication. The person doing the indicating may be the same person as the artist or a separate individual such as a recording engineer, in various embodiments.

In some embodiments, a recording artist may need to record several takes of a performance of a component performance element to successfully record a mistake-free take. The navigation component 106 allows the artist or the engineer to, at the time of performance, signify whether a take was mistake-free and thus eligible for inclusion in a final combined performance.

In some embodiments, an embodiment can be designed such that the artist will record only one mistake-free take of each component performance element and thus the system can be capable of automatically assembling a single media file of the program by concatenating all of these mistake-free takes from the final combined performance. In some embodiments, the system may be designed such that the artist may record multiple mistake-free takes to allow the decision about which takes to include in a final combined performance to be made later after reviewing the performances. In such an embodiment, the system can allow an artist to record multiple performances of at least one of the number of component performance elements and can include a selection component that can allow a person to select which one of the multiple performances should be included in a final combined performance.

In some embodiments, it will not be necessary for the artist to decide about the form of a final combined performance, such as when the artist records alternative elements, such as “United States Patent and Trademark Office” and “USPTO”. In such an embodiment, the multiple performance elements can then be made available such that the system can create multiple versions of a final combined performance. In some embodiments, the navigation component can allow the artist to review performances, go back and/or forward through the component performance elements or otherwise navigate through the script of component performance elements.

An embodiment for media assembly can also include a storage component 104 to hold at least one take of an artist's performance of at least one of the number of component performance elements. This storage component can be a computer hard drive or it can be any other suitable medium capable of recording the likeness of a performance. The storage component 104 can be part of a device for media assembly. The storage component 104 can also be a server located on network in a location other than the one in which the artist is performing.

An embodiment for media assembly can include a mechanism that combines at least two takes corresponding to different component performance elements into a single edited media file representing a final combined performance 103. In such embodiments, if the artist recorded only one mistake-free take of a series of linear component performance elements, the mechanism can automatically concatenate all of the mistake-free performances into a single edited media file.

It can be beneficial in some instances that a media assembly embodiment may not have to include component performance elements that are combined into a single media file. This is because today's media playback technology is capable of playing back a sequence of individual media files while giving the listener a continual listening experience. As such, while some embodiments may combine the component performance elements into a single media unit for distribution, some embodiments may distribute a set of individual component performance elements with some other mechanism being relied upon to play the media files sequentially.

As such, in some instances, a “final combined performance” can be a single media file. A final combined performance can also be a set of component performance element files that, when played back in sequence, make up a media program. A final combined performance can also be a set of component performance elements that, when selectively played back in a number of different sequences (some of which may include all or less than all of the total number of component performance elements), make up a media program.

Embodiments can also allow additional media content, such as musical interludes, to be placed, in some embodiments, automatically, into a final combined performance. For example, if the media program is an audio book, the author may want musical interludes between the chapters. An embodiment can allow for such interludes to be automatically placed into the final combined performance. In other embodiments, additional media such as music may be mixed with the narrator's voice to create a “voice-over” effect.

An embodiment can also allow component performance elements to be further processed by an audio processing program. This processing can be performed individually on the component performance elements or on a combined single file made up of concatenated component performance elements. Such processing can include audio dynamic range compression or expansion, equalization, or any other audio engineering operation. The processing can also include conversion to any number of final audio formats such as MP3 or WAV files.

An embodiment can also allow the component performance elements to be uploaded to a server for distribution. This final distribution can be a telecommunications network, a broadcast network, or a CD, for example. The files for the component performance elements can be uploaded individually or concatenated into a lesser number of composite elements.

In addition, the functionality of any embodiment can be designed to include interaction with a central service or repository. For example, in some embodiments, the narrative script may be stored on a web server. A user can click on a web link associated with the narrative script which opens the narrative script in the device. The device manages the recording process for each paragraph and then, when the narration is complete, the device assembles the final audio file or files, which may include audio interludes (e.g., music) or other audio elements. Once the file or files are created, the device can upload them, for example via FTP, to a web server, among other suitable destinations.

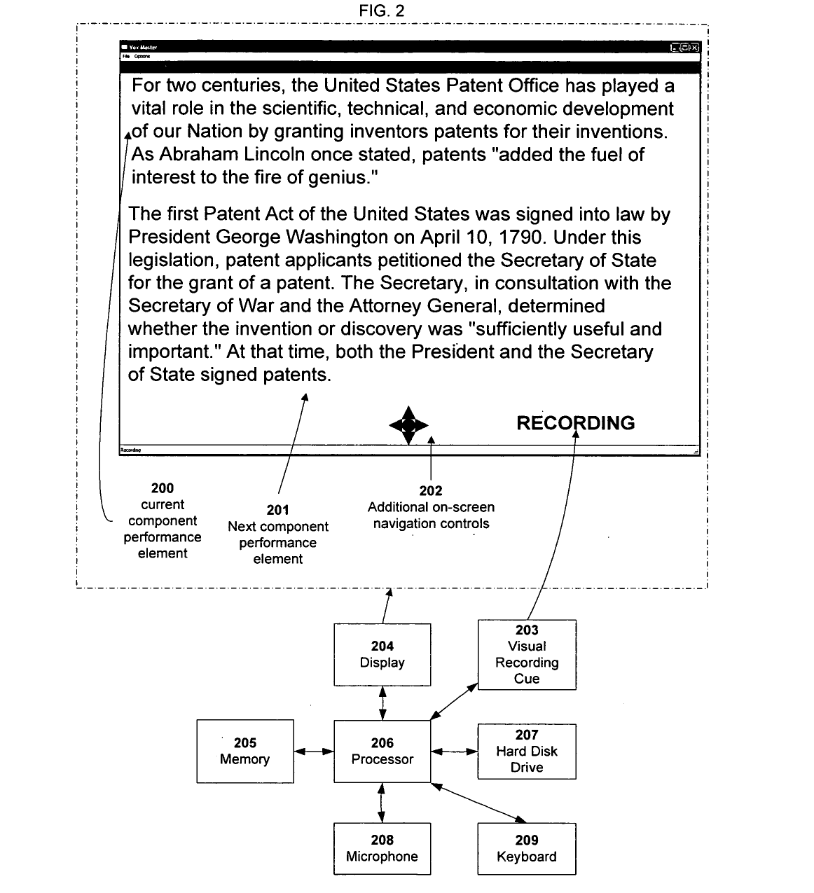

FIG. 2 is a screen shot and a block diagram that further illustrates the elements of an embodiment for media assembly. The embodiment of FIG. 2 can use a laptop computer to provide the memory 205, processor 206, display 204, cueing 203 (which can be integrated into the display or can be an external mechanism), recording 208, navigation 209, and storage components 207. FIG. 2 illustrates an embodiment of some example details that can be included in the display component.

For instance, FIG. 2 provides a textual representation of the first component performance element 201, a textual representation of the second component performance element 202, navigation controls 203, which, when shown on the display, can be clicked by a mouse and thus allow the artist to start the process and indicate a successful, mistake-free take of the performance of the component performance element; and, a cueing component 203, which in this example is a visible word “RECORDING” which is superimposed on the display. In this embodiment, there can also be accompanying audio cues (beeps) which count down, for example, in one second increments to allow the artist to time when the visual recording cue will appear thus perfectly timing the beginning of their performance.

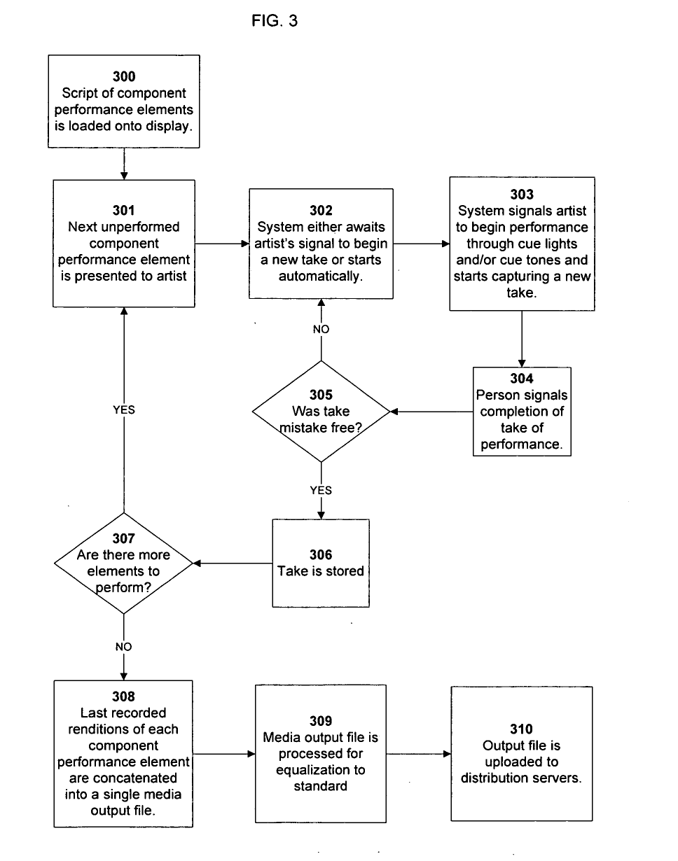

FIG. 3 is a flow chart that illustrates a method embodiment for media assembly. A script, which contains a textual representation of the component performance elements, can be loaded into memory 300. Then, the next unrendered component performance element can be displayed on the display component 301.

In various embodiments, the system can either automatically start the performance process or the artist can signal 302 that he is ready to begin a new take. The system can be designed to cue the artist to begin a take through any number of different mechanisms.

Such a system can be designed to include both an audio and visual cue component. An audio cue may be a series of three beeps at one second intervals followed by a visual “tally” light or on screen “RECORDING” notice exactly one second after the last beep. When the recording tally comes on, the recording component starts capturing a new take of the performance of a component performance element.

The artist can then signal the end of the performance 304 such that the recording process ends just after the performance is complete. If the take was mistake-free 305, the artist can choose to store 306 the take or 302 re-record a new take of the current performance element.

If the take was mistake-free and the there are more elements to perform 307, then the display component can present the next component performance element 301. If there are no more elements to perform, then the system can 308 concatenate all of the mistake-free takes into a single media file.

Some method embodiments do not utilize concatenation as the media files can still be sequentially played back later by a device such as a CD or DVD player with no additional editing required before distribution. The system can also process 309 the media file or files for audio quality such as equalization or dynamic range compression and can upload the file 310 to a media server for immediate release and distribution.

Although specific embodiments have been illustrated and described herein, those of ordinary skill in the art will appreciate that an arrangement calculated to achieve the same techniques can be substituted for the specific embodiments shown. This disclosure is intended to cover all adaptations or variations of various embodiments of the present disclosure.

It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the present disclosure includes other applications in which the above structures and methods are used.

Therefore, the scope of various embodiments of the present disclosure should be determined with reference to the appended claims, along with the full range of equivalents to which such claims are entitled. In the foregoing Detailed Description, various features are grouped together in a single embodiment for the purpose of streamlining the disclosure.

This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

I claim:

1. A computer readable medium having executable instructions that can be executed by a processor to perform a method, comprising:
manipulating at least one textual script file representing a number of component performance elements of a media program;
displaying a visual representation of at least one of the number of component performance elements;
cueing the artist to begin performing a take of a component performance element;
capturing a take of an artist's performance of at least one of the number of component performance elements;
indicating whether mistakes were made by the artist during the performance of the take; and
storing at least one mistake-free take of an artist's performance in memory.

2. The medium of claim 1, wherein the method includes recording multiple takes of performances of at least one of the number of component performance elements and selecting which one of the multiple takes should be included in a final combined performance.

3. The medium of claim 1, wherein the method includes combining at least two takes corresponding to different component performance elements into a single media file representing a final combined performance.

4. The medium of claim 1, wherein the method includes placing additional media content into a final combined performance.

5. The medium of claim 1, wherein the method includes further processing of the component performance elements by a media processing program.

6. The medium of claim 1, wherein the method includes uploading the component performance elements to a server for distribution.

7. The medium of claim 1, wherein the method includes storing the narrative script on a web server and allowing a user to select a web link associated with the narrative script, and presenting the narrative script on a display component.

8. A method for media assembly, the method comprising:
loading at least one textual script file representing a number of component performance elements of a media program into a memory;
displaying a visual representation of at least one of the number of component performance elements;
cueing the artist to begin performing a take of a component performance element;
capturing a take of a performance of at least one of the number of component performance elements;
indicating whether mistakes were made by the artist during the performance of the take; and
storing at least one take of a mistake-free performance of at least one of the number of component performance elements.

9. The method of claim 8, wherein the method includes recording multiple takes of at least one of the number of component performance elements and a selection step that can allow a person to select which one of the multiple takes should be included in a final combined performance.

10. The method of claim 8, wherein at least two takes corresponding to different component performance elements are combined into a single media file representing a final combined performance.

11. The method of claim 8, wherein additional media content is automatically placed into a final combined performance.

12. The method of claim 8, wherein the component performance elements are further processed for media quality.

13. The method of claim 8, wherein the component performance elements are uploaded to a server for distribution.

14. The method of claim 8, wherein the narrative script may be stored on a web server allowing the user to click on a web link allowing the narrative script to open in a presentation device.

15. A media assembly device comprising:
a processor;
a memory in communication with the processor; and
computer executable instructions storable in the memory and executable by the processor to capture and assemble a number of component performance elements into a final combined performance.

16. The device of claim 15 wherein the device loads at least one textual script file representing a number of component performance elements.

17. The device of claim 15 wherein the device presents a visual representation of at least one of the number of component performance elements on a display.

18. The device of claim 15 wherein the device cues the artist to begin performing a take of a component performance element.

19. The device of claim 15 wherein the device captures a take of a performance of at least one of the number of component performance elements.

20. The device of claim 15 wherein the device allows a person to indicate when mistakes were made in performing a take of a component performance element.

21. The device of claim 15 wherein the devices stores at least one take of at least one of the number of component performance elements.
